(19) United States
(12) Patent Application Publication
(10) Pub. No.: US 2025/0155731 A1
(43) Pub. Date: May 15, 2025

(54) MULTIPLE INTEGRATED GLASSES SYSTEM

(71) Applicant: Zenni Optical, Inc., Novato, CA (US)

(72) Inventors: Steven LEE, Novato, CA (US); Julia ZHEN, Novato, CA (US); ChyrSong TING, Novato, CA (US); Sana DHAWAN, Novato, CA (US)

(21) Appl. No.: 18/949,876

(22) Filed: Nov. 15, 2024

Related U.S. Application Data
(60) Provisional application No. 63/599,442, filed on Nov. 15, 2023.

(51) Int. Cl. G02C 9/04

(52) U.S. Cl. CPC G02C 9/04; G02C 2200/02

(57) ABSTRACT

An eyeglass can include an auxiliary component that is selectively mountable onto an eyeglass frame. The eyeglass frame can include a pair of lenses. The eyeglass can include a first set of magnetic mounts that are attachable to the eyeglass frame. The first set can include at least four magnet mounts for each lens of the eyeglass frame. The eyeglass can optionally include a second set of magnetic mounts attachable to the auxiliary component. The first and second sets of magnetic mounts can be positioned in corresponding locations for securing the auxiliary component to the eyeglass frame. The auxiliary component system can also be flipped up or down while still attached to the eyeglass frame.

### CROSS-REFERENCE TO RELATED APPLICATIONS

This application claims the benefit of U.S. Provisional Application No. 63/599,442, filed Nov. 15, 2023, the entirety of which is incorporated herein by reference.

### BACKGROUND

### Field of the Inventions

The present disclosure is generally related to an eyeglass apparatus having an auxiliary component that can provide aesthetic or functional use, including vision correction and/or protective functionality.

### Description of the Related Art

Eyewear serves various purposes, including shielding the eyes from sunlight, filtering specific wavelengths like blue light, and providing an aesthetic enhancement. Optical-quality materials can be layered to enhance or modify their properties, enabling tailored solutions for different visual or protective needs. By combining these materials, eyewear can achieve multifunctionality, addressing both practical and aesthetic considerations in a single design.

While eyewear is widely available, the integration of advanced optical technologies allows for improved user experience, offering innovative ways to enhance vision, reduce eye strain, and provide protection, all within compact and adaptable designs.

### SUMMARY

The present disclosure relates generally to a combination eyeglass and auxiliary component attachment system for the purpose of creating a functional multi-use optical system that can be adapted for numerous use cases. The system and method may not require an individual to have multiple pairs of eyeglasses for various functional uses, but, rather, can use the present disclosure to create a number of combination eyeglass solutions that can be used to achieve any unique function thereof.

In accordance with some embodiments, a combination eyeglass and auxiliary component selectively mountable thereon, can include an eyeglass frame having a pair of lenses mounted thereon. The auxiliary component can include one or more lenses that can be coupled to eyeglass and positioned over a lens or lenses of the eyeglass. Some embodiments may include a mount component on the eyeglass frame and/or the auxiliary component to facilitate the interconnection and articulation of these components relative to each other and secure attachment when in use by the wearer.

In some embodiments, the eyeglass frame and the auxiliary component may be configured to include complimentary mount components. For example, the mount components can comprise magnetic, adhesive, and/or mechanical components.

In some embodiments, the mount components can comprise magnetic features that are positioned adjacent to the outer edges of the auxiliary component corresponding to the placement of the magnets attached to the eyeglass frame. Further, a complementary set can include the same number of magnetic mounts as the first set, with each of the magnet mounts in the complimentary set having an opposite magnetic pole as compared with the magnetic pole for the counterpart magnetic pole of the first set.

In some embodiments, the mount components may be incrementally adjustable to accommodate the user's specific optical requirements.

In some embodiments, the mount components can provide an automatic “default” setting to which the combination eyeglass and auxiliary component may be drawn when placed in proximity to each other in the approximate position.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 is a perspective view illustrating a combination eyeglass, according to some embodiments.

FIG. 2 is a perspective view of an eyeglass frame having a mount component, according to some embodiments.

FIG. 3 is a rear perspective view of the eyeglass frame of FIG. 2 illustrating optional features of the mount component, according to some embodiments.

FIG. 4 is a rear perspective view of an auxiliary component, according to some embodiments.

FIGS. 5A-8 illustrate side, cross-sectional views of features of mounting components of an eyeglass frame and an auxiliary component, according to some embodiments.

FIG. 9 is a perspective view of another embodiment of a combination eyeglass, according to some embodiments.

FIG. 10 is a side, cross-sectional view of an interconnection of mounting components of a combination eyeglass in which the mounting components provide an electrical connection therebetween, according to some embodiments.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations, and its several details are capable of modification in various other respects, all without departing from the scope of the subject technology. Accordingly, the summary, drawings, and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for case of understanding.

FIG. 1 is a block diagram that describes an eyeglass apparatus or combination eyeglass 100, according to some embodiments of the present disclosure. In some embodiments, the eyeglass apparatus 100 may include eyeglass frame 110 and an auxiliary component 111 selectively mountable thereon. The auxiliary component 111 can be magnetically or mechanically coupled to the eyeglass frame 110 of the eyeglass apparatus 100.

For example, the eyeglass frame 110 can comprise a first mount, and the auxiliary component 111 can comprise a second mount that can mate with the first mount of the eyeglass frame 110. When coupled together, the auxiliary component 111 and the eyeglass frame 110 can be securely coupled to each other to permit active use by the wearer. Indeed, absent a separating force applied thereto by the wearer to manually detach the auxiliary component 111 from the eyeglass frame 110, the auxiliary component 111 can maintain engagement with the eyeglass frame 110 during use.

In accordance with some embodiments, the first mount can comprise a magnetic mount, and the second mount can comprise a magnetic mount. However, the first mount and/or the second mount can comprise any of a variety of magnetic and/or mechanical coupling components. For example, the coupling of the auxiliary component to the eyeglass frame can be performed using one or more coupling components, such as magnets, adhesive, and/or mechanical fasteners. Such coupling mechanisms can include snap connectors, magic tape, hook and loop fasteners, clips, screws, bolts, clamps, quick release joints, or other fasteners.

Accordingly, various embodiments can provide the user with an interchangeable lens system that allows the user to select an auxiliary component that provides functional and/or aesthetic properties desired by the wearer. For example, the auxiliary component can allow the wearer to select a functional property, such as a physical barrier, sunglasses to protect from wind, blowing dust, sand, and other airborne debris that could irritate the eyes and cornea, which may damage the eye. Further, in some embodiments in which the auxiliary component includes one or more lenses, the auxiliary component can provide a vision correction or prescriptive lens, bifocals, trifocals, or other specialty prescription lenses. Moreover, the auxiliary component can enable the wearer to add certain functionality, such as audio, power, and/or visual capabilities, which can be performed by the auxiliary component.

In accordance with some embodiments, the auxiliary component 111 can comprise a frame that at least partially supports or circumscribes at least one lens 114.

The auxiliary component 111 can provide an attachment capability, such as a magnetic mount that can mate with the eyeglass frame 110. For example, the eyeglass frame 110 can comprise a first set of magnetic mounts 116 that can be magnetically coupled with a second, complementary set of magnetic mounts 117 that are coupled to a frame 112 of the auxiliary component 111. As shown in FIG. 1, the first set of magnetic mounts 116 can align with and be magnetically secured to the second set of magnetic mounts 117 of the eyeglass frame 112.

In some embodiments, as shown in FIG. 1, the second set of magnetic mounts 117 can extend rearwardly from an upper portion of an orbital of the frame 112 and the coupled to an upper portion of an orbital of the eyeglass frame 110. The first and second sets of magnetic mounts 116, 117 can extend along substantially an entire width of the lens to permit secure placement of the auxiliary component 111 against the eyeglass frame 110.

The first set of magnetic mounts 116 can comprise a plurality of magnetic features, such as two, three, four, five, or more, that can be integrated into the frame 110 or extend outwardly from the frame 110, as shown in FIG. 1. Similarly, the second set of magnetic mounts 117 can comprise a plurality of magnetic features, such as two, three, four, five, or more, that can be integrated into the frame 112 or extend outwardly from the frame 112, as shown in FIG. 1. In accordance with some embodiments, the polarity of adjacent magnetic features can alternate in order to advantageously facilitate or trigger a self-alignment or default positioning of the auxiliary component 111 relative to the frame 112.

Further, the presence of magnetic and/or other types of attachment means, as discussed herein, at lateral positions above or on the lateral portions of the lens can advantageously enable the auxiliary component 111 to self-align with the eyeglass frame 110 and provide secure attachment thereto. Moreover, the self-aligning and secure attachment between these components can tend to ensure that the auxiliary component 111 is seamlessly mated against the frame 110, thereby mitigating any risk of accidental snagging or catching that might cause a separating force to be applied against the auxiliary component 111 and thereby separated from the frame 110.

In some embodiments, the self-alignment can be facilitated by alignment of X, Y, and Z axes of one or more corresponding features of the frame 110 and the auxiliary component 111. This self-alignment can be facilitated by a strong magnetic attraction between the components and/or a manual or chronic force that drives the components toward an aligned position.

Optionally, the first and second sets of magnetic mounts 116, 117 can comprise a side or ear stem magnetic feature 116a, 117a. The ear stem magnetic features 116a, 117a can provide a magnetic coupling on a lateral and medial location of the assembly of the auxiliary component 111 and the frame 112. This magnetic coupling can provide significant rigidity in the coupling between these components. Moreover, the coupling can also be used to incorporate an electrical coupling between the auxiliary component 111 and the frame 112, to provide an electrical contact between the auxiliary component 111 and the frame 112 when the auxiliary component 111 is coupled to the eyeglass frame 112 for permitting electrical communication between the eyeglass frame and the auxiliary component.

In some embodiments, the eyeglass frame 112 may include a pair of lenses 113 mounted therein. However, the eyeglass frame 112 of the auxiliary component 111 can also support a single lens or shield that can be positioned across the eyeglass frame 110. Further, the eyeglass frame 110 can also comprise separate lens sections (not illustrated) that differ from the illustrated frame 112 in that separate lens sections can be separate by omitting a bridge portion of the frame 112 (which couples the orbitals together across a central section of the auxiliary component 111).

Referring now to FIG. 2, an eyeglass apparatus 300 is shown that can comprise a frame 302, opposing ear stems 304, a bridge portion 306, and left and right orbitals 308, 310. As discussed above with regard to the eyeglass apparatus 100, the eyeglass apparatus 300 can be configured to be coupled with an auxiliary component. In the embodiment of the eyeglass apparatus 300 illustrated in FIG. 2, the bridge portion 306 can be configured to include one or more mount components 320. The mount components 320 can comprise any of a variety of coupling components, such as magnetic, adhesive, and/or mechanical fasteners, as discussed herein.

As illustrated in FIG. 2, the mount components 320 can be positioned along a forward face or section 330 and/or a top face or section 332 of the frame 302 and, in some embodiments, along the bridge portion 306. As illustrated in FIG. 3, in some embodiments, the mount components 320 can be positioned along a rearward face or section 340 and/or a bottom face or section 342 of the frame, and in some embodiments, along the bridge portion 306. These mount components 320 represent potential positions of a mount component that can be used with the eyeglass apparatus 300. In some embodiments, a single mount component may be used along only a forward, rearward, top, or bottom face or section of the frame. However, one or more mount components can be incorporated into the frame 302 along one or more of the faces or sections thereof, in order to provide a desired adjustability or configurability of the eyeglass apparatus 300.

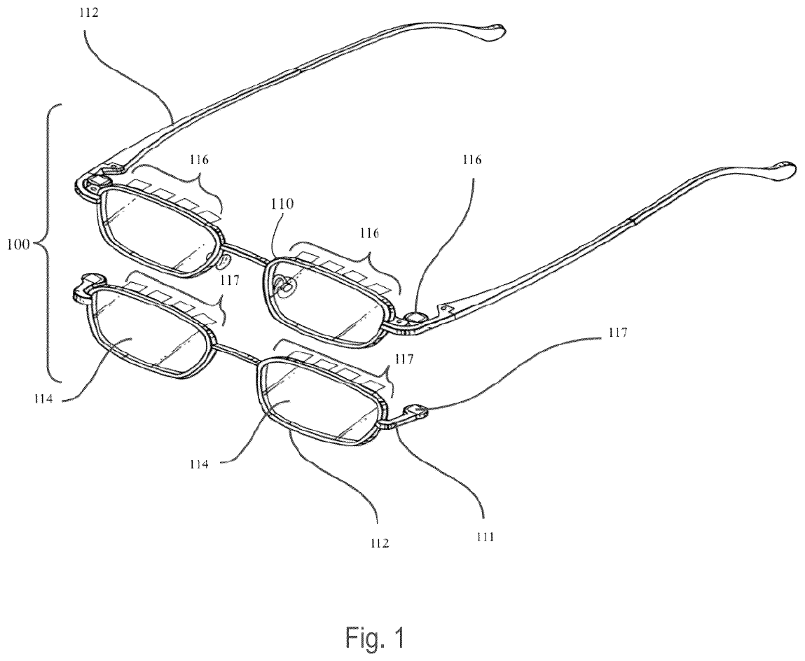

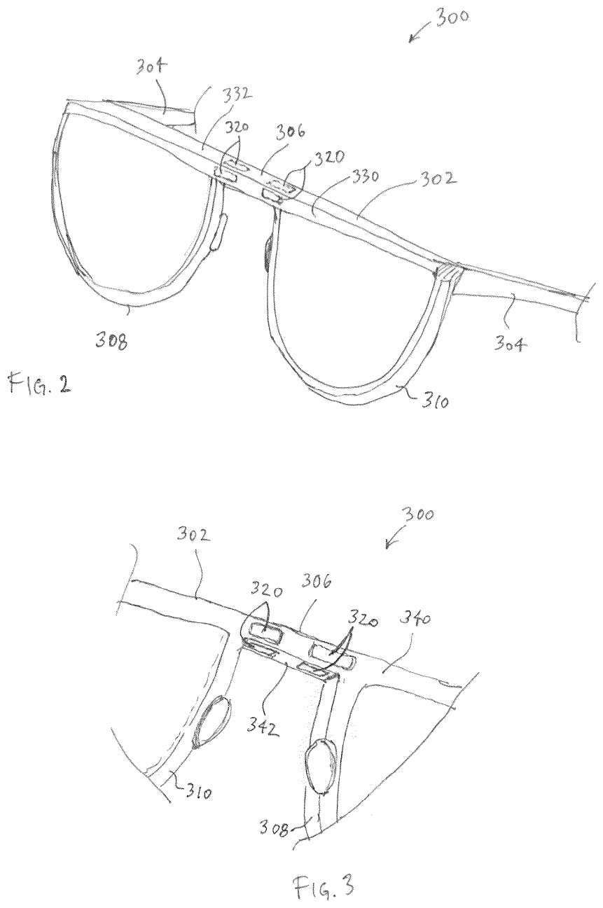

For example, referring to FIG. 4, the eyeglass apparatus 300 can be used in combination with an auxiliary component 400. The auxiliary component 400 shown in FIG. 4 can comprise one or more mount components 402 that are coupled to a frame 404 of the auxiliary component 400. Optionally, the auxiliary component 400 can comprise one or more lenses, but in accordance with some embodiments, the lens or lenses can be omitted (e.g., for providing a benefit other than optical, such as an aesthetic effect and/or electronic functionality, such as visual or audio capabilities). The mount component(s) 402 can be configured to be coupled with the corresponding mount components 320 of the frame 302 of the eyeglass apparatus 300. In accordance with some embodiments, the mount component 402 can comprise a flange structure 410 having a rearwardly extending ledge 412 that extends from the flange structure 410. The mount component 402 can also comprise one or more coupling components, such as magnetic, adhesive, and/or mechanical attachment mechanisms, as discussed herein with regard to other coupling mechanisms.

The auxiliary component 400 illustrated in FIG. 4 is shown in a configuration in which the mount component 402 extends rearwardly from the frame 404 so that the auxiliary component 400 can sit in front of the eyeglass apparatus 300 when coupled thereto (i.e., with the eyeglass apparatus 300 being positioned intermediate the auxiliary component 400 and the wearer's face). However, in accordance with some embodiments, the mount component 402 can be coupled to a front or anterior portion of the frame 404 and extend in a forward or anterior direction relative to the frame 404 so that the auxiliary component 400 can sit behind the eyeglass apparatus 300 when coupled thereto (i.e., intermediate the eyeglass apparatus 300 and the wearer's face).

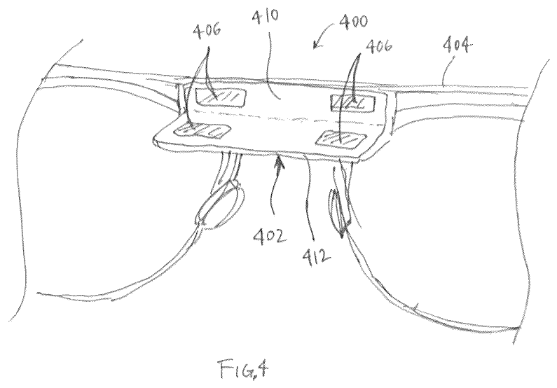

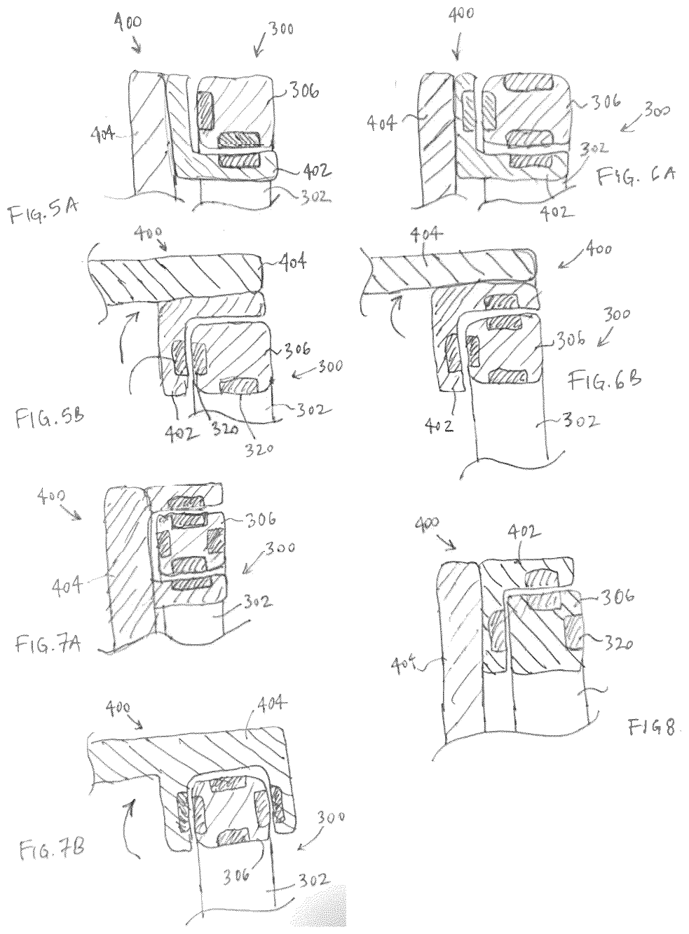

With reference to FIGS. 4, 5A, and 5B, the auxiliary component 400 and the eyeglass apparatus 300 can be configured to be coupled together in at least two different orientations. For example, as shown in the side view of FIG. 5A, the mount component 402 of the auxiliary component 400 can be coupled to the bridge portion 306 of the eyeglass apparatus 300 such that the frame 404 of the auxiliary eyeglass component 400 sits against the frame 302 of the eyeglass apparatus 300. FIG. 5A illustrates a “flipped down” position in which the wearer looks through both the auxiliary component 400 and the eyeglass apparatus 300 while wearing the eyeglass. FIG. 5B illustrates the auxiliary component 400 in a “flipped up” position, where the auxiliary component 400 has been rotated upwardly about the bridge section 306 and re-coupled to the bridge section 306 with the auxiliary component 400 extending in a direction away from the frame 302 of the eyeglass apparatus 300.

Each of the embodiments shown in FIGS. 5A, 5B, 6A, 6B, 7A, and 7B illustrate alternative features of the auxiliary component 400 and the eyeglass apparatus 300, which can be combined or omitted in alternative embodiments. Thus, the bridge section 306 of the eyeglass apparatus 300 can be configured with one, two, three, or four mount components 320. Further, the mount component 402 of the auxiliary component 400 can be configured to include a flange component having a flange section that extends away from the frame of the auxiliary component. The flange section can be configured to sit below the bridge section 306, as shown in FIG. 5A, or be configured to sit above the bridge section 306, as shown in FIG. 8, when the auxiliary component 400 is in the first or “flipped down” position.

Other various configurations and mating cross-sections can be incorporated into the shape and mating between the auxiliary component and the eyeglass apparatus. Although FIGS. 5A-8 illustrate a generally polygonal or square cross-sectional mating tween the bridge section and the mount component, other cross-sectional shapes, such as circles, rectangles, triangles, and the like can be used. Further, mechanical fasteners, recesses, and/or protrusions can be incorporated into the engagement mechanisms used by the auxiliary component and the eyeglass apparatus.

For example, the eyeglass apparatus can comprise a keyhole in the eyeglass frame that allows for coupling, and the auxiliary component can comprise an attachment protrusion that fits into the keyhole of the eyeglass frame to couple and snap into place.

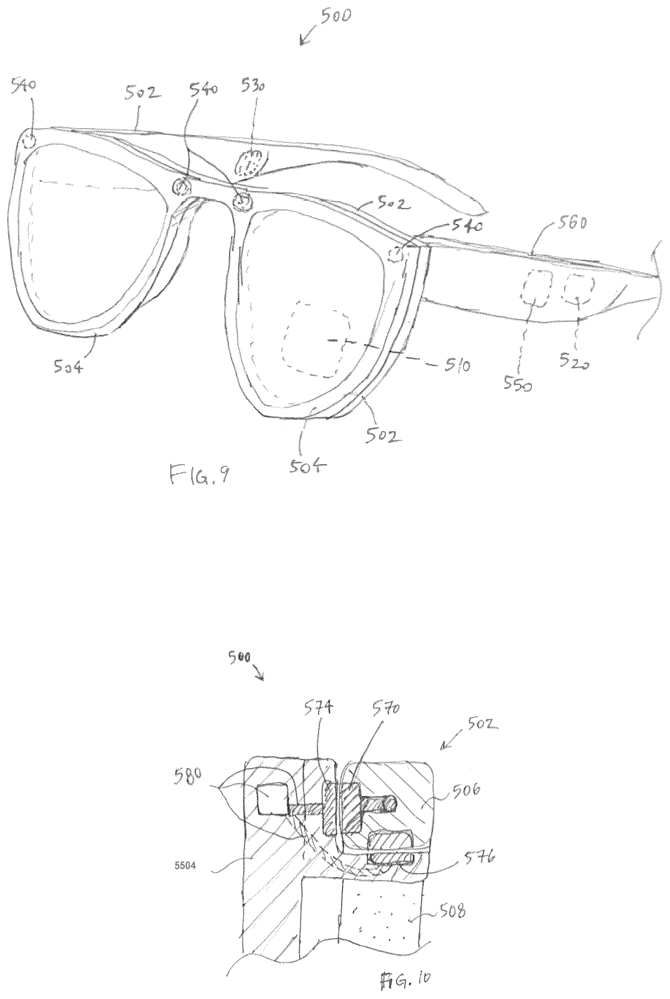

Referring now to FIG. 9, an eyeglass apparatus 500 is illustrated that can comprise one or more electronic features. The electronic features can be shared between an eyeglass frame 502 and an auxiliary component 504. The auxiliary component 504 may comprise one or more electronic features, such as an electronic optical display system 510. The eyeglass apparatus 500 can also comprise a battery component 520, one or more audio components or outputs 530, one or more voice or camera components or inputs 540, and/or Internet connectivity modules or processors 550. These and other components can be incorporated into the eyeglass frame 502 and/or the auxiliary component 504. Further, the eyeglass frame 502 can comprise orbitals 560 that can house one or more of these components.

FIG. 10 illustrates a potential connection mechanism between the frame 502 (showing a bridge portion 506 of the frame and an orbital portion 508) and the auxiliary component 504. As shown, an electrical contact 570 of the frame 502 can be electrically coupled with an electrical contact 574 of the auxiliary component 504. In accordance with some embodiments, the auxiliary component 504 can comprise a secondary electrical contact 576 that can move into electrical connection with the contact 570 if the auxiliary component 504 is moved from the “flipped down” position to the “flipped up” position. Further, the electrical contact of the auxiliary component 504 can be coupled to an electrical system 580 that communicates with one or more electrical components of the auxiliary component 504.

In accordance with some embodiments, the eyeglass frame may be also wired for an electrical circuit connected to an LCD panel with a backlight and display component or a mirror capable of at least one of reflecting and splitting images generated on the LCD panel and directing them into the eye of the user.

Optionally, at least one of the magnet mounts may be capable of activating and deactivating a battery cell that serves to power the display system via a magnetic on/off switch. For example, when the auxiliary component 504 is moved to the “flipped up” position, the electrical contact 576 can trigger the onboard electronics of the eyeglass apparatus 500 to move to a power conservation mode, such as turning off.

Various embodiments of the eyewear disclosed herein have been shown in FIGS. 1-10. The arrangement of magnets and the mount component geometries disclosed in the illustrated embodiments have been found to provide superior alignment and engagement between the frame and the auxiliary component. In particular, some embodiments provide for an arrangement of magnets in which the attracting surfaces are oriented at approximately 90° with respect to each other, or in a perpendicular arrangement. Such embodiments that include perpendicular or oblique orientations of the surfaces relative to each other provide superior engagement between the eyewear and the auxiliary component. This is due in part to the attractive force is being exerted in multiple directions, as well as the adjacent geometric feature (a corner or edge, as shown in various embodiments), which collectively reduce the likelihood that the auxiliary component will be in advertently disengage from the eyewear due to the unique combination of a general mechanical mating relationship and attractive forces exerted in multiple directions between the eyewear and the auxiliary component.

For example, as shown in FIGS. 5A-7B and 10, the eyeglass apparatus or optical lens attachment system of can include a mount or mounting component and a frame that collectively form a transverse mounting system in which magnetic axes of the mount or mounting component and the frame are arranged in a transverse relationship. In some embodiments, the magnetic axes of the magnets are oriented in a transverse relationship related to each other. Further, in some embodiments, the magnetic axes of the magnets can be oriented in a perpendicular relationship related to each other.

Moreover, the embodiments shown in FIGS. 5A-7B and 10, also illustrate the presence of the mechanical or structural mating relationship, which can comprise one or more corners, edges, protrusions, and/or recesses that mate in one or more fixed relationships, thus providing one or more corresponding fit positions between the mount or mounting component and/or the frame. In accordance with some embodiments, the mechanical or structural features can be overlaid with or integrated with the coupling (adhesive or magnetic) components, such that the attractive components are integrated or present along adjacent faces or structures of the mount or mounting component and/or the frame.

Advantageously, the present disclosure has found that this unique engagement and arrangement can also enable the eyewear and auxiliary component to utilize smaller and visually unobtrusive structures, e.g. magnets and the like, which allow for further improvements in the aesthetic qualities of the eyewear and auxiliary component. Thus, the unique geometries of the embodiments disclosed herein provide various advantageous and superior benefits compared to prior systems that may have included only a magnetic attractive force in a single direction.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. An eyeglass apparatus comprising: an eyeglass frame that supports at least one lens, the frame comprising a first magnetic mount; an auxiliary component comprising a second magnetic mount and being removably attachable to the eyeglass frame, the second magnetic mount (i) corresponding in placement to the first magnetic mount when the auxiliary component is magnetically coupled to the eyeglass frame in a first position and (ii) having an opposite magnetic pole to the first magnetic mount; wherein the auxiliary component can be repositioned from the first position to be (i) magnetically coupled to the eyeglass frame in a second position that is pivoted from the first position and (ii) at least partially spaced apart from the at least one lens of the eyeglass frame.

Clause 2. The eyeglass apparatus of Clause 1, wherein the auxiliary component comprises a central bridge that is coupled to a respective bridge of the eyeglass frame, the first position being achieved when the auxiliary component is coupled to the eyeglass frame at the central bridge and the respective bridge and the auxiliary component is positioned adjacent to the at least one lens of the eyeglass frame.

Clause 3. The eyeglass apparatus of Clause 2, wherein the second position is achieved when the auxiliary component is pivoted upwardly about the respective bridge of the eyeglass frame.

Clause 4. The eyeglass apparatus of any of the preceding Clauses, wherein the first magnetic mount is disposed along a central bridge of the eyeglass frame.

Clause 5. The eyeglass apparatus of Clause 4, wherein the first magnetic mount comprises a pair of magnets.

Clause 6. The eyeglass apparatus of Clause 4, wherein the first magnetic mount comprises two pairs of magnets.

Clause 7. The eyeglass apparatus of Clause 4, wherein the first magnetic mount comprises a first pair of magnets that are disposed along a first surface of the central bridge and a second pair of magnets that are disposed along a second surface of the central bridge, the first surface being oriented at an angle relative to the second surface.

Clause 8. The eyeglass apparatus of Clause 7, wherein the angle is between about 45° and about 135°.

Clause 9. The eyeglass apparatus of Clause 7, wherein the angle is between about 65° and about 115°.

Clause 10. The eyeglass apparatus of Clause 7, wherein the angle is between about 80° and about 100°.

Clause 11. The eyeglass apparatus of Clause 7, wherein the angle is about 90°.

Clause 12. The eyeglass apparatus of any of the preceding Clauses, wherein the second magnetic mount is disposed along a central bridge of the auxiliary component.

Clause 13. The eyeglass apparatus of Clause 12, wherein the second magnetic mount comprises a pair of magnets.

Clause 14. The eyeglass apparatus of Clause 12, wherein the second magnetic mount comprises two pairs of magnets.

Clause 15. The eyeglass apparatus of Clause 12, wherein the second magnetic mount comprises a first pair of magnets that are disposed along a first surface of the central bridge and a second pair of magnets that are disposed along a second surface of the central bridge, the first surface being oriented at an angle relative to the second surface.

Clause 16. The eyeglass apparatus of Clause 15, wherein the angle is between about 45° and about 135°.

Clause 17. The eyeglass apparatus of Clause 15, wherein the angle is between about 65° and about 115°.

Clause 18. The eyeglass apparatus of Clause 15, wherein the angle is between about 80° and about 100°.

Clause 19. The eyeglass apparatus of Clause 15, wherein the angle is about 90°.

Clause 20. The eyeglass apparatus of Clause 12, wherein the second magnetic mount comprises a flange that extends outwardly from the central bridge of the auxiliary component.

Clause 21. The eyeglass apparatus of Clause 20, wherein at least one magnet is supported by the flange of the auxiliary component.

Clause 22. The eyeglass apparatus of Clause 21, wherein the auxiliary component comprises at least one magnet disposed along the central bridge, separate from the at least one magnet of the flange.

Clause 23. The eyeglass apparatus of any of the preceding Clauses, wherein the eyeglass frame comprises a central bridge having frame mating component, and wherein the auxiliary component comprises a central bridge having an auxiliary mating component that is complementary to and compatible with the frame mating component to permit the auxiliary component to be magnetically coupled to the eyeglass frame.

Clause 24. The eyeglass apparatus of Clause 23, wherein the frame mating component comprises an outer profile that can be mated with an inner profile of a receptacle of the auxiliary mating component.

Clause 25. The eyeglass apparatus of Clause 23, wherein the frame mating component comprises a polygonal outer profile that can be mated with a polygonal inner profile of a receptacle of the auxiliary mating component.

Clause 26. The eyeglass apparatus of Clause 23, wherein the frame mating component comprises a rectangular outer profile that can be mated with a rectangular inner profile of a receptacle of the auxiliary mating component.

Clause 27. The eyeglass apparatus of Clause 23, wherein the frame mating component comprises the first magnetic mount and the auxiliary mating component comprises the second magnetic mount.

Clause 28. The eyeglass apparatus of any of the preceding Clauses, wherein the eyeglass frame comprises an electrical contact that can be electrically connected with an electrical contact of the auxiliary component when the auxiliary component is coupled to the eyeglass frame for permitting electrical communication between the eyeglass frame and the auxiliary component.

Clause 29. The eyeglass apparatus of any of the preceding Clauses, wherein the eyeglass frame comprises at least one of a microphone or a speaker.

Clause 30. The eyeglass apparatus of any of the preceding Clauses, wherein the eyeglass frame comprises a processor configured for internet connectivity.

Clause 31. The eyeglass apparatus of any of the preceding Clauses, wherein the eyeglass frame comprises electrical circuitry connected to an LCD panel with a backlight and display component or a mirror capable of at least one of reflecting or splitting images generated on the LCD panel for directing them into the eye of the user.

Clause 32. The eyeglass apparatus of any of the preceding Clauses, further comprising a sensor for activating or deactivating a display system.

Clause 33. The eyeglass apparatus of any of the preceding Clauses, further comprising a sensor for activating or deactivating a battery cell that powers the display system via a magnetic on/off switch.

Clause 34. An eyeglass apparatus comprising: an eyeglass frame having a pair of lenses mounted therein; an auxiliary component selectively attachable to the eyeglass frame; a first set of magnetic mounts affixed to the eyeglass frame and comprising at least four magnet mounts for each lens of the eyeglass frame; and a second set of magnetic mounts affixed to outer edges of the auxiliary component, wherein each of the second set of magnetic mounts (i) corresponds in placement to a respective one of the first set of magnetic mounts and (ii) has an opposite magnetic pole to the respective one of the first set of magnetic mounts.

Clause 35. The eyeglass apparatus of Clause 34, wherein the auxiliary component comprises an electronic optical display system.

Clause 36. The eyeglass apparatus of any one of Clauses 34 to 35, wherein the first and second sets of magnetic mounts are permanently affixed to the eyeglass frame and the outer edges of the auxiliary component, respectively.

Clause 37. The eyeglass apparatus of any one of Clauses 34 to 36, wherein the auxiliary system comprises a wraparound sunglass attachment that wraps around the entire eyeglass frame as a sun protector.

Clause 38. The eyeglass apparatus of any one of Clauses 34 to 37, wherein the auxiliary system comprises a safety eyewear protection system that protects the side temples and clips on with additional side magnets to the side temples for added safety eyewear protection.

Clause 39. The eyeglass apparatus of any one of Clauses 34 to 38, wherein the magnetic mounts are incrementally adjustable to accommodate a user's specific optical requirements.

Clause 40. The eyeglass apparatus of any one of Clauses 34 to 39, wherein the first and second magnetic mounts provide an automatic default setting or position, drawing the eyeglass and the auxiliary component together when placed in proximity to each other in an approximate position.

Clause 41. The eyeglass apparatus of any one of Clauses 34 to 40, wherein the first and second magnetic mounts are configured to self-align to draw the eyeglass frame and the auxiliary component together to the default setting or position when central bridges of the eyeglass frame and the auxiliary component are brought into contact with each other.

Clause 42. The eyeglass apparatus of any one of Clauses 34 to 41, wherein the eyeglass frame comprises at least one of a microphone or a speaker.

Clause 43. The eyeglass apparatus of any one of Clauses 34 to 42, wherein the eyeglass frame comprises a processor configured for internet connectivity.

Clause 44. The eyeglass apparatus of any one of Clauses 34 to 43, wherein the eyeglass frame comprises electrical circuitry connected to an LCD panel with a backlight and display component or a mirror capable of at least one of reflecting or splitting images generated on the LCD panel for directing them into the eye of the user.

Clause 45. The eyeglass apparatus of any one of Clauses 34 to 44, further comprising a sensor for activating or deactivating a display system.

Clause 46. The eyeglass apparatus of any one of Clauses 34 to 45, further comprising a sensor for activating or deactivating a battery cell that powers the display system via a magnetic on/off switch.

Clause 47. The eyeglass apparatus of any one of Clauses 34 to 46, wherein the eyeglass frame comprises an electrical contact that can be electrically connected with an electrical contact of the auxiliary component when the auxiliary component is coupled to the eyeglass frame for permitting electrical communication between the eyeglass frame and the auxiliary component.

Clause 48. An optical lens attachment system comprising: an optical lens component comprising a forward attachment component that provides an attachment mechanism in a forward direction away from the optical lens component; and an eyeglass having a mounting component on a rearward section of the eyeglass, the mounting component being configured to couple with the forward attachment component of the optical lens to permit the optical lens to be coupled with the eyeglass.

Clause 49. The optical lens attachment system of Clause 48, wherein the eyeglass comprises a frame.

Clause 50. The optical lens attachment system of any one of Clauses 48 to 49, wherein the eyeglass comprises a rimless frame.

Clause 51. The optical lens attachment system of any one of Clauses 48 to 50, wherein the mounting component of the eyeglass is disposed along a central bridge of the eyeglass.

Clause 52. The optical lens attachment system of any one of Clauses 48 to 51, wherein the optical lens component comprises a lens and a frame that at least partially circumscribes the lens.

Clause 53. The optical lens attachment system of any one of Clauses 48 to 52, wherein the optical lens component comprises a frame and the forward attachment component is secured to the frame.

Clause 54. The optical lens attachment system of any one of Clauses 48 to 53, wherein the forward attachment component comprises an attachment stick mechanism extending from a front surface of the optical lens component.

Clause 55. The optical lens attachment system of any one of Clauses 48 to 54, wherein the forward attachment component comprises at least one of: a magnet, snap, magic tape, clip, or fastener.

Clause 56. The optical lens attachment system of Clause 55, wherein the mounting component of the eyeglass comprises a recess that is configured to mate with the forward attachment component to permit engagement between the optical lens component and the eyeglass via the magnet, snap, magic tape, clip, or fastener.

Clause 57. The optical lens attachment system of any one of Clauses 48 to 56, wherein the forward attachment component and the counting component collectively form a stick-on system having a recess or hole and a respective protrusion to facilitate a mechanical interconnection between the optical lens component and the eyeglass.

Clause 58. The optical lens attachment system of Clause 57, wherein the mounting component of the eyeglass comprises a connector socket configured to engage with a protrusion of the forward attachment component.

Clause 59. The optical lens attachment system of Clause 57, wherein the mounting component of the eyeglass comprises a protrusion configured to engage with a connector socket of the forward attachment component.

Clause 60. The optical lens attachment system of Clause 57, wherein the stick-on system comprises a recess and flange magnetic attachments.

Clause 61. The optical lens attachment system of Clause 60, wherein the recess and flange magnetic attachments are configured to be aligned along an axis of rotation along a horizontal and vertical line.

Clause 62. The optical lens attachment system of Clause 57, wherein the stick-on attachment system comprises at least one of the following: a magnet, snap, magic tape, clip, or fastener.

Clause 63. The optical lens attachment system of Clause 57, wherein the stick-on attachment system of the optical lens flange attachment engages in an opposed stick-on recess of the sunglass lens in a manner of one of magnetic, snap, and coupling. For example, the stick-on attachment may comprise a keyhole in the eyeglass frame that allows for coupling, and the auxiliary component can comprise an attachment protrusion that fits into the keyhole of the eyeglass frame to couple and snap into place.

Clause 64. The optical lens attachment system of Clause 57, wherein the stick-on system consists of a recess and flange magnetic attachments, the magnetic attachments are aligned with their axis of rotation along a horizontal and vertical line, and the auxiliary magnetic attachment contains magnetic hematite.

Clause 65. The eyeglass apparatus or optical lens attachment system of any of the preceding Clauses, wherein a mount or mounting component and a frame comprise an transverse mounting system in which magnetic axes of the mount or mounting component and the frame are arranged in a transverse relationship.

Clause 66. The eyeglass apparatus or optical lens attachment system of Clause 65, wherein the mount or mounting component and/or the frame comprise a magnet having a magnetic axis, wherein the magnetic axes of the magnets are oriented in a transverse relationship related to each other.

Clause 67. The eyeglass apparatus or optical lens attachment system of Clause 66, wherein the mount or mounting component and/or the frame comprise a magnet having a magnetic axis, wherein the magnetic axes of the magnets are oriented in a perpendicular relationship related to each other.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

As used herein, the term “about” is relative to the actual value stated, as will be appreciated by those of skill in the art, and allows for approximations, inaccuracies, and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

As used herein, the term “comprising” indicates the presence of the specified integer(s), but allows for the possibility of other integers, unspecified. This term does not imply any particular proportion of the specified integers. Variations of the word “comprising,” such as “comprise” and “comprises,” have correspondingly similar meanings.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. An eyeglass apparatus comprising:
an eyeglass frame that supports at least one lens, the frame comprising a first magnetic mount;
an auxiliary component comprising a second magnetic mount and being removably attachable to the eyeglass frame, the second magnetic mount (i) corresponding in placement to the first magnetic mount when the auxiliary component is magnetically coupled to the eyeglass frame in a first position and (ii) having an opposite magnetic pole to the first magnetic mount;
wherein the auxiliary component can be repositioned from the first position to be (i) magnetically coupled to the eyeglass frame in a second position that is pivoted from the first position and (ii) at least partially spaced apart from the at least one lens of the eyeglass frame.

2. The eyeglass apparatus of claim 1, wherein the auxiliary component comprises a central bridge that is coupled to a respective bridge of the eyeglass frame, the first position being achieved when the auxiliary component is coupled to the eyeglass frame at the central bridge and the respective bridge and the auxiliary component is positioned adjacent to the at least one lens of the eyeglass frame.

3. The eyeglass apparatus of claim 2, wherein the second position is achieved when the auxiliary component is pivoted upwardly about the respective bridge of the eyeglass frame.

4. The eyeglass apparatus of claim 1, wherein the first magnetic mount comprises at least one pair of magnets disposed along a central bridge of the eyeglass frame.

5. The eyeglass apparatus of claim 4, wherein the first magnetic mount comprises a first pair of magnets that are disposed along a first surface of the central bridge and a second pair of magnets that are disposed along a second surface of the central bridge, the first surface being oriented at an angle relative to the second surface.

6. The eyeglass apparatus of claim 5, wherein the angle is between about 45° and about 135°.

7. The eyeglass apparatus of claim 1, wherein the second magnetic mount comprises at least one pair of magnets disposed along a central bridge of the auxiliary component.

8. The eyeglass apparatus of claim 7, wherein the second magnetic mount comprises a first pair of magnets that are disposed along a first surface of the central bridge and a second pair of magnets that are disposed along a second surface of the central bridge, the first surface being oriented at an angle relative to the second surface.

9. The eyeglass apparatus of claim 8, wherein the angle is between about 45° and about 135°.

10. The eyeglass apparatus of claim 7, wherein the second magnetic mount comprises a flange that extends outwardly from the central bridge of the auxiliary component.

11. The eyeglass apparatus of claim 10, wherein at least one magnet is supported by the flange of the auxiliary component.

12. The eyeglass apparatus of claim 11, wherein the auxiliary component comprises at least one magnet disposed along the central bridge, separate from the at least one magnet of the flange.

13. The eyeglass apparatus of claim 1, wherein the eyeglass frame comprises a central bridge having frame mating component, and wherein the auxiliary component comprises a central bridge having an auxiliary mating component that is complementary to and compatible with the frame mating component to permit the auxiliary component to be magnetically coupled to the eyeglass frame.

14. The eyeglass apparatus of claim 13, wherein the frame mating component comprises the first magnetic mount and the auxiliary mating component comprises the second magnetic mount.

15. The eyeglass apparatus of claim 1, wherein the eyeglass frame comprises an electrical contact that can be electrically connected with an electrical contact of the auxiliary component when the auxiliary component is coupled to the eyeglass frame for permitting electrical communication between the eyeglass frame and the auxiliary component.

16. The eyeglass apparatus of claim 1, wherein the eyeglass frame comprises at least one of a microphone or a speaker.

17. The eyeglass apparatus of claim 1, wherein the eyeglass frame comprises a processor configured for internet connectivity.

18. The eyeglass apparatus of claim 1, wherein the eyeglass frame comprises electrical circuitry connected to an LCD panel with a backlight and display component or a mirror capable of at least one of reflecting or splitting images generated on the LCD panel for directing them into the eye of the user.

19. The eyeglass apparatus of claim 1, further comprising a sensor for activating or deactivating a display system and a battery cell that powers the display system via a magnetic on/off switch.

20. An eyeglass apparatus comprising:
an eyeglass frame having a pair of lenses mounted therein;
an auxiliary component selectively attachable to the eyeglass frame;
a first set of magnetic mounts affixed to the eyeglass frame and comprising at least four magnet mounts for each lens of the eyeglass frame; and
a second set of magnetic mounts affixed to outer edges of the auxiliary component, wherein each of the second set of magnetic mounts (i) corresponds in placement to a respective one of the first set of magnetic mounts and (ii) has an opposite magnetic pole to the respective one of the first set of magnetic mounts.
